(19) United States
(12) Patent Application Publication
(10) Pub. No.: US 2025/0088087 A1
(43) Pub. Date: Mar. 13, 2025

(54) THREE BODY ROTARY ACTUATOR WITH INDEPENDENT STATOR

(71) Applicant: Cyrus Theophilos Grimes, Columbus, OH (US)

(72) Inventor: Cyrus Theophilos Grimes, Columbus, OH (US)

(21) Appl. No.: 18/892,169

(22) Filed: Sep. 20, 2024

Related U.S. Application Data
(60) Provisional application No. 63/581,665, filed on Sep. 10, 2023.

(51) Int. Cl. H02K 49/04; B25J 9/12; H02K 5/20; H02K 7/10; H02K 7/116; H02K 9/20; H02K 11/21; H02K 11/25; H02K 13/00

(52) U.S. Cl. CPC H02K 49/043; B25J 9/126; H02K 5/207; H02K 7/1004; H02K 7/116; H02K 9/20; H02K 11/21; H02K 11/25; H02K 13/003; H02K 2205/09

(57) ABSTRACT

The present disclosure introduces a compact, stackable electromechanical actuator optimized for precise torque control in robotic and automation systems. This actuator features three distinct bodies: a drive shaft with an attached rotor, an independently rotating stator, and a supporting frame. The stator connects to a control medium, such as a cable or belt, allowing free rotation within the frame. Driven by an external power source, the rotor operates alongside the stator, facilitating efficient torque transmission. The modular design enables integration of multiple rotor-stator pairs along a shared drive shaft, offering customizable configurations for varying torque and power requirements. By utilizing magnetic fields for torque transmission without physical contact, the actuator reduces wear and maintenance compared to traditional systems. This ensures precise torque control, quick response times, and smooth operation, making it suitable for applications demanding reliable force transmission and space-efficient integration into robotic and compact mechanical environments.

### PRIOR ART

In electromechanical systems, especially those used in robotics, automation, and prosthetics, precise control, safety, adaptability, and reliability are essential. While existing technologies attempt to address these requirements, they often present critical limitations, underscoring the need for further innovation.

U.S. Ser. No. 10/525,588B2 describes a cable-driven system using magnetorheological (MR) fluid clutches to control movement in an antagonist system. While this system provides compliance through controlled slippage and resistance, it faces challenges related to the differences in force output between transitional actuation and intentional force application. In transitional modes, as the output rotation begins to match the speed of the prime driver, the MR fluid is fully engaged, resulting in higher force output. However, as slippage occurs and the actuator engages with an object, the force transmitted by the clutch decreases due to the dynamic behavior of the MR fluid, making it less effective in delivering consistent torque. Additionally, managing fluid centrifugation and complex seal designs further complicates the system's adaptability and precision in highly dynamic environments.

U.S. Ser. No. 11/692,593B2 offers a stackable friction clutch-based torque distribution device. Although it provides precise mechanical control, the reliance on mechanical friction as a primary means of torque transmission leads to inevitable wear and tear, reducing the system's lifespan and requiring frequent maintenance. The complexity added by servo-controlled clutch engagement increases the system's size and cost, making it challenging to integrate into compact or space-sensitive environments.

Similarly, KR101740904B1 and KR20230075262A describe systems that simulate muscle behavior through linear motion driven by electromagnetic attraction between a series of stacked movable elements. While mimicking biological muscles effectively, these designs are complex and do not utilize traditional mechanical advantages, such as rotary motion and gearing. JP2007082352A and U.S. Ser. No. 11/635,096B2 describe linear actuators powered by arrays of solenoid coils. Though innovative, these devices face significant challenges in construction, control, and energy efficiency, limiting their applicability in broader, more practical scenarios.

U.S. Pat. No. 9,985,497B2 presents a rotary-based linear actuator that uses mechanical advantage to optimize force output. However, this design sacrifices compliance and compactness, resulting in a bulky system that may not meet the needs of applications requiring fine control and adaptability in confined spaces.

Early technologies such as U.S. Pat. No. 2,771,879 (Schultz) disclose magnetically activated torque couplings designed to transmit torque between one input and one output member, with torque limiting features. Although innovative for its time, Schultz's system primarily focuses on torque limiting without offering the precision and dynamic control necessary in modern applications. The reliance on friction-based components also introduces wear and demands frequent maintenance, which reduces the system's efficiency and long-term viability.

U.S. Pat. No. 3,269,208 (Vaughn and Mendenhall) describes a belt-engaging pulley system using an electromagnetic coil to axially move pulley halves and control torque transmission. This system is effective in belt-driven applications but is limited by its mechanical nature, which introduces wear and requires frequent maintenance. Moreover, its focus on belt-driven mechanisms limits its adaptability to modern electromechanical systems where precision, scalability, and low maintenance are essential.

European Patent EP2393992B1 (Prütz) and DE202011051969U1 describe systems incorporating eddy current clutches to control the engagement between a motor and its driven load. While these systems offer precise control in specific applications such as pile driving and automotive auxiliary systems, they are specialized for large-scale, robust operations always with the focus being on a singular output. Their design does not translate well to applications requiring fine-tuned torque control, adaptability, or integration of a plurality of actuators in a modular system.

Despite these advancements, existing systems often struggle with limitations such as complexity, wear, bulkiness, and a lack of adaptability. They fail to provide the precise, scalable, and low-maintenance solutions required in modern applications like robotics, automation, and prosthetics. These limitations underscore the need for a new approach—one that combines the precision of electromagnetic systems with the scalability and modularity necessary for integrating multiple actuators on a single drive shaft.

### BACKGROUND OF THE INVENTION

Actuation systems are essential components across a wide array of applications, including industrial machinery, robotics, prosthetics, and animatronics. In fields such as prosthetics, healthcare robotics, and android-type robots interacting with humans, the demand for adaptability, compliance, and safety is paramount. Traditional actuation systems typically rely on motors or servos that generate motion by rotating a rotor against a stator fixed to a support structure. These systems focus on position-based control, which can lead to issues in dynamic environments where the ability to adapt to unexpected obstacles or resistance is critical for safe and effective operation.

In conventional actuators and servos, the stator remains fixed while the rotor is responsible for generating motion. This design inherently limits the number of actuation points that can be accommodated in a confined space, as each actuator requires independent housing and attachment points. Moreover, the focus on precise positional control creates limitations in flexibility, particularly when compared to biological systems. In contrast, biological muscles can dynamically adjust their force output to meet changing demands, offering natural compliance and adaptability. While Series Elastic Actuators (SEAs) have been developed to introduce some level of compliance, they often feature fixed or difficult-to-control compliance levels, making them less adaptable in environments where conditions are unpredictable. Furthermore, traditional systems require an independently mounted SEA for each degree of freedom, increasing system complexity, size, and cost.

Traditional electromechanical actuators, including motors, servos, and stepper motors, often struggle to replicate the adaptive behavior of biological muscles. Biological systems inherently exhibit compliance to external forces, adjusting their movements dynamically without rigidly maintaining a fixed position. In contrast, traditional actuators must rely on simulated compliance—where control systems and sensors detect and respond to external forces. However, simulated compliance introduces additional complexity, as it requires advanced control algorithms and real-time feedback mechanisms. These systems can experience delays in response, reducing the fluidity of motion and increasing the risk of collisions or damage in environments requiring rapid adaptation.

Furthermore, conventional electromechanical actuators experience difficulties when holding a position. Maintaining a static position typically requires continuous power, which can lead to thermal buildup. This is especially problematic in applications where the actuator must remain stationary for extended periods, as cooling mechanisms—often dependent on rotor movement—become ineffective. Overheating during prolonged stalling can degrade motor components, reducing efficiency and increasing the likelihood of system failure. To mitigate this, some systems incorporate rigid holding mechanisms, such as worm gears or high-ratio gearboxes, which can maintain position without power. However, these rigid mechanisms sacrifice compliance and adaptability, as they are designed to resist movement entirely, creating a risk of injury or damage when unexpected forces are encountered.

In dynamic environments, particularly those involving direct human interaction or the need for rapid adaptation—such as search and rescue robotics or healthcare applications—the inability of traditional systems to yield or adapt to unforeseen external forces becomes a critical limitation. The rigid holding mechanisms used to maintain position without power, while energy-efficient, significantly hinder compliance and flexibility. Simulated compliance can offer some level of adaptability, but it often requires continuous power and complex control systems, compounding the thermal management issues associated with prolonged operation.

Historically, the use of a single prime mover to power multiple actuation points has been a common method, dating back to the era of steam engines and water wheels that powered entire factories. Applied to robotics and automation, this concept allows for multiple points of actuation to be driven from a central power source within a compact space, which is particularly beneficial where space is limited. However, while such configurations improve spatial efficiency, they do not inherently solve issues related to compliance, adaptability, and precise force control.

Prior art has introduced various clutch-based systems, including friction clutches and magnetorheological (MR) fluid clutches, to offer compliance and smooth force control. These systems generate drag against a prime mover to allow slip under excessive force, mimicking the force control capabilities of biological muscles. While MR fluid clutches offer rapid response and controllability, they face significant challenges in robotic applications, including friction losses, complex seal designs to prevent fluid leakage, and fluid centrifugation that can lead to particle separation over time. These complications increase design complexity and cost, making such systems less feasible for many practical applications.

Mechanical friction clutches, while simpler, suffer from wear due to the sliding contact between moving parts, reducing performance over time and increasing the need for maintenance. Additionally, mechanical friction clutches face challenges related to heat generation during continuous operation, especially when required to hold a static position. This leads to thermal management issues, as these systems lack effective mechanisms for dissipating heat when the rotor remains stationary, but the armature is still powered. The continuous power input, necessary to maintain position, exacerbates the risk of overheating, further limiting the long-term reliability of such systems.

Thus, the limitations of traditional actuation systems, particularly regarding compliance, thermal management, and positional holding, underscore the need for a new approach to actuation. A system that can more effectively replicate the dynamic behavior of biological muscles—providing enhanced compliance, adaptability, and safety—while addressing the challenges of thermal buildup and control complexity is essential for advancing actuation technology in fields like robotics, prosthetics, and industrial automation.

### FIELD OF THE INVENTION

The present invention relates generally to actuation systems for mechanical devices. More specifically, the present invention pertains to methods, systems, apparatuses, and devices for facilitating the actuation and distribution of power in mechanical systems, such as robotic systems, prosthetics, and other automated machinery, using an innovative arrangement of electromagnetic clutch actuators.

The invention introduces a novel actuator that incorporates a third reference frame into traditional electrical machines used for actuation. This design allows the rotor and stator to interact in their usual manner—transferring force through electromagnetism—while also providing a constant force output even when the output mechanism or end effector is in a state of force equilibrium and remains stationary. This approach offers several advantages over traditional actuation systems, such as MR fluid and mechanical friction clutches, including reduced wear, more precise force control, and a modular, space-efficient design.

The stackable nature of the electromagnetic actuator allows for multiple rotor-stator pairs to be assembled along a common shaft, enabling compact integration and customization for specific torque and power requirements. This makes the invention particularly suitable for applications where space is limited, such as in prosthetics, compact robotics, and other automated systems.

The invention finds applicability in the domains of human-robot interaction, healthcare robotics, and industrial automation, where the need for safety, adaptability, and efficient operation is critical. However, the actuator's unique features and benefits make it valuable for a wide range of mechanical systems that require precise force control, compact design, and reliable performance.

### SUMMARY OF THE INVENTION

The present invention relates to an improved actuation and power distribution system for machine automation and robotics. By leveraging electromagnetic fields for precise control and efficient power distribution, the system overcomes limitations of conventional systems such as parasitic friction losses, complexity, and high costs. Utilizing controllable forces generated through magnetic fields and/or eddy currents, the invention enables a single prime mover to power a drive shaft connected to multiple degrees of freedom with enhanced precision and control, resulting in reduced complexity, mass, and cost.

In traditional electromechanical actuation systems, servos comprise a rotor and a stator forming a two-frame configuration, where the stator is fixed to a stationary frame or structure. When the rotor drives linkages connected to subsequent components-such as robotic arms or joints—the generated torque is transmitted through these linkages to the end effector, like a gripper or tool. Reaction forces from interacting with the environment or manipulating loads at the end effector are transmitted back through the linkages to the stators of the servos. Since the stators are rigidly fixed, these reaction forces are absorbed by the stationary frame, creating a closed-loop force system. While this setup balances forces between moving rotors, fixed stators, and mechanical linkages, it lacks inherent compliance to external forces. Consequently, the system may force movements to achieve predetermined positions, potentially leading to safety concerns or reduced adaptability when unexpected forces are encountered.

Addressing these limitations, the present invention introduces an innovative actuation system that fundamentally alters the conventional arrangement by decoupling the stator from its fixed mounting, effectively creating a third movable frame or body. By allowing the stator to rotate independently, the interaction between the stator and rotor is redefined, inverting the traditional operation of an electrical machine. In conventional systems, the rotor's rotational velocity varies to meet system demands, stopping or holding position upon achieving the desired outcome. In contrast, this invention maintains a constant rotor velocity, driven by an external prime mover, regardless of the actuation state. Instead of the rotor generating work transmitted through mechanical means connected back to the stationary frame, the stator in this system generates work, transmitting mechanical energy through linkages or cables connected to the end effector and the frame. This configuration introduces a unique compliance mechanism, as the stator can adjust its position in response to external forces, allowing the system to safely absorb and respond to such forces. This enhances operational safety and adaptability, marking a significant departure from traditional Series Elastic Actuators (SEA), which achieve compliance through elastic elements between the rotor and its work output back to the frame, often increasing system complexity and response time.

In this invention, the stator or armature can drive various mechanical outputs, including but not limited to control cables, belts, chains, or other transmission methods, while the rotor maintains continuous rotation even when the actuation is at a steady state. Central to the invention is the unique three-body configuration comprising the rotor, the stator, and the stationary frame. This frame or cage houses the spinning rotor and stator and serves as a foundational structure against which the generated forces act, enabling controlled compliance and enhanced safety.

To support the various mechanical outputs, the system may employ bulkheads—extensions of the frame that aid in routing and aligning components such as cables, gearboxes, or other transmission systems. These bulkheads enhance the system's structural integrity, ensuring that generated forces are efficiently transmitted and reducing wear on components. Additionally, the bulkheads can integrate electronics, sensors, and encoders, providing real-time feedback and precise control of the system. This continuous monitoring of operational parameters—such as torque, speed, and position—further optimizes system performance.

Unlike traditional Series Elastic Actuators (SEA), which achieve compliance through mechanical elasticity, sensors, and complex closed-loop controls, the present invention relies on the electromagnetic interaction between the rotating stator and rotor, modulated by the stationary frame. This electromagnetic compliance offers a higher degree of precision and control without the added complexity and potential drawbacks of mechanical elasticity. Electromagnetic machines in this system do not experience the same frictional losses associated with capstans or magnetorheological clutches; many can fully disengage, leaving only minimal losses due to bearings or bushings. The control of the applied force is highly precise, typically being either linearly or quadratically proportional to the applied current, and in the case of eddy current devices, directly proportional to rotor speed. These systems exhibit minimal hysteresis and are less influenced by mechanical effects on the output. In its simplest embodiment, the invention utilizes an eddy current configuration, where the relationship between the drag torque produced can be mathematically described as:

$$τ = k \cdot {B}^{2} \cdot Δω$$

### Where:

τ is the drag torque,
k is a constant dependent on the device's geometry and material properties,
B is the magnetic field strength,
Δω is the angular velocity difference between the rotor and the stator.
   Furthermore, there is no need to change poles; a signal as simple as an analog DC current can control the output.

In embodiments employing an eddy current configuration, the continuously spinning rotor helps address cooling challenges often associated with eddy current brakes. As the rotor is always spinning at an optimal speed, it can be designed to create convective air currents that aid in cooling. Moreover, the ultimate force remains constant, with the speed differential between the rotor and the stator optimized for force output.

A salient advantage of the present invention is its compact and modular design. The system's architecture allows for the integration of multiple stator-rotor pairs adjacently on a single drive shaft, all contained within the same frame or cage. This design facilitates multiple, independent actuation points within a confined space, making it particularly advantageous for applications requiring spatial efficiency or closely spaced independent movements.

Like any electromagnetic machine, the output of the present invention can be adjusted by varying the stator-rotor pair geometry. Increasing the area and diameter of the stator-rotor pair enhances the ultimate torque achievable (increasing k from the above formula), with a wider unit producing more output than a thinner unit of the same diameter. Similarly, a larger diameter unit produces more torque than one with a smaller diameter of the same thickness. Thus, available space can be optimized for power and dimensions. Additionally, a single drive shaft may employ a series of stator-rotor pairs of varying dimensions, with each actuation tailored to the specific force it needs to produce.

Torque-multiplying methods, such as planetary gears or gearboxes, can be employed to magnify the torque output. Lever arms may also allow for higher torque in smaller spaces, bearing in mind that some gearing configurations or reductions may impact the compliance of the actuation.

Furthermore, the present invention champions energy efficiency. In specific embodiments employing a generator for actuation, there is potential for energy recapture that would conventionally dissipate as heat. This reclaimed energy can be channeled back into the system, optimizing overall energy consumption—a feature particularly beneficial in scenarios where energy conservation is paramount.

Additionally, the rotational speed of the rotor can be adjusted to optimize performance and match the current requirements of the actuator, allowing for dynamic control and adaptability in various operational scenarios. By modulating the rotor's rotational speed, the actuation system can fine-tune force output, response time, and energy consumption based on immediate application demands. This feature ensures that the actuator operates at peak efficiency, whether rapidly winding a control cable for swift movements or maintaining a steady force for sustained tasks. The ability to adjust the rotor's speed in real-time provides a mechanism to adapt to changing external conditions, such as varying loads or environmental factors, ensuring consistent performance and prolonging the system's lifespan. This dynamic speed control not only enhances the versatility of the actuation system but also contributes to safety, as it can swiftly adapt to unexpected obstacles or resistances, minimizing potential damages or malfunctions.

A key objective of the present invention is to provide significant reductions in cost and mass compared to one-to-many style actuation systems found in the prior art. For example, control servos in pneumatic or hydraulic one-to-many systems are complex mechanical devices that are expensive to fabricate. In contrast, the present invention utilizes common electromagnetic machine components optimized for manufacturability, performance, and price. Other components can be produced with injection-molded parts.

The invention achieves these objectives by providing a stackable arrangement of electromagnetic actuators—each controllable for output torque and, in some embodiments, speed of contraction—arranged along a common drive axle powered by a prime mover. The rotor elements interact electromagnetically with the stator to control the drag force generated, with varying rotor-stator geometries optimized for specific force requirements and degrees of motion. Each stator/armature coil operates independently, receiving its own control signal, allowing for precise and individualized actuation across multiple degrees of freedom.

To transmit power effectively, each electromagnetic actuator includes a method of power transmission—such as cables, tendons, or other mechanical means—that redirects the torque or power generated by the armature to the intended point of actuation. Additionally, the system can be adapted for rotational output using gears, belts, or chain mechanisms. Bulkheads, as structural extensions of the frame, support wire routing and gearboxes, enhancing the system's rigidity and stability. These bulkheads ensure that generated forces are efficiently transmitted, maintain alignment, and reduce component wear, thus contributing to the system's operational lifespan and reliability.

The present invention is applicable to any system utilizing electromagnetic machines, including but not limited to generators, motors, and eddy current devices. It supports various methods of supplying electrical power to the armature coils, such as pulse-width modulation (PWM), analog signals, or other techniques. Power can be transmitted to the stator through various means, including brush contacts, clock spring circuits, photovoltaic systems, or any method capable of delivering the necessary current to the stator.

The invention applies to any system that uses a tendon, Bowden cable, or similar mechanism to transmit output power from the electromagnetic actuator to the degrees of freedom being controlled.

It is applicable to systems that include ball joints or other multi-axis degrees of freedom controlled or powered by the outputs of electromagnetic actuators. Additionally, it applies to systems using proportional, integral, derivative (PID), or other types of software control systems to manage input signals of the electromagnetic actuators.

The invention supports any system that uses any type of actuation or mechanical power input for the rotating drive axle, including electric motors, hydraulic motors, gas piston engines, gas turbine engines, chemical motors, or compressed gas motors.

It is applicable to systems utilizing conductive materials such as copper, aluminum, silver, carbon fiber yarns, composites, or other suitable materials for the coils or conductive elements of the electromagnetic actuators.

The invention applies to systems that control, in whole or in part, bipedal, quadrupedal, or other types of robots, as well as any type of industrial machinery or equipment.

It supports systems employing active or passive thermal cooling technologies, including liquid cooling of the rotors, to manage heat generated by ohmic heating during electromagnetic work, thereby maintaining device performance and internal resistance.

The invention is applicable to systems designed to allow the stackable electromagnetic actuators to be quickly and easily removed as a unit with minimal effort, enabling cost-effective and efficient routine maintenance.

it applies to systems equipped with strain gauges, thermal sensors, or other sensors embedded in the electromagnetic machine to facilitate power control, heat monitoring, and optimization of performance and lifespan.

The invention is applicable to systems that incorporate encoders, Hall effect sensors, or other embedded sensors within the electromagnetic machine to manage the velocity of actuation and optimize movement of the controlled degrees of freedom. This enables closed-loop control, allowing for precise and responsive actuation. By integrating these sensors directly into the machine, the system can achieve higher levels of performance optimization. Sensor data can be utilized by the control system to adapt power input and actuation parameters in real-time, ensuring smooth, efficient, and precise motion control.

The invention is applicable to a wide range of applications, including but not limited to automobiles, other transport vehicles, boats, aircraft, earth-moving equipment, heavy construction equipment, package delivery and sorting systems, military uses, medical robotics, elderly care home robots, dinosaur robots for museums, exploration and rescue operations, construction machines and robots, factory equipment and robots, farm equipment and robots, and mining equipment and robots.

It applies to systems where electromagnetic actuators are distributed in a manner that positions each electromagnetic machine, or a combination of machines, proximal to the degrees of freedom being controlled, rather than being centralized on a rotating power input tube.

The invention is applicable to a variety of specialized environments, including underwater applications, space and aerospace applications, and prosthetics. This includes applications in artificial limbs, gait assistance devices, exoskeletal applications, human power augmentation, and human power amplification.

The present invention meets these objectives and addresses limitations of prior art by providing an automatic machine equipped with a torque distribution system and at least one movable part associated with a degree of freedom. The torque distribution system includes a prime mover capable of delivering rotating power, which can be transferred by any suitable means to the drive axle. This drive axle can be rotated by the prime mover, and the system can support one or more arrays of actuators along different drive shafts, all powered by the same prime mover.

The torque distribution system also includes at least one mechanical power transmission to the movable part associated with the first degree of freedom. The system comprises a support frame that secures the common rotating power input drive axle and the electromagnetic actuator(s) within the automatic machine. The prime mover may be remotely mounted, with rotational power transferred to the frame by any suitable method, allowing for flexible configurations and the ability to drive multiple arrays of actuators.

The automatic machine incorporating a torque distribution system may include at least one electromagnetic actuator that activates movement of the first movable part along its associated degree of freedom. While this electromagnetic actuator may preferably be configured as an eddy current actuator or a generator-type actuator, the system is not limited to these configurations and may utilize other suitable electromagnetic devices depending on specific application requirements.

The first movable part associated with the first degree of freedom can include various mechanical elements such as ball joints, levers, or gears. The system is designed to be adaptable to a wide range of mechanical transmission methods, including cables, belts, chains, gear systems, or other conventional or unconventional methods of transferring mechanical energy. The automatic machine may also be equipped with a control system that manages input signals to the electromagnetic actuator, utilizing control algorithms such as proportional, integral, or derivative (PID) systems for precise and responsive control.

The torque distribution system can be powered by various types of motors, including electric motors, hydraulic motors, gas piston engines, gas turbines, chemical motors, or compressed gas motors. The drive shaft, which transmits rotational power within the system, can be constructed from a wide range of materials, such as metals, plastics, composites, stainless steel, titanium, or other materials suitable for the specific demands of the application.

The automatic machine may incorporate active or passive thermal management technologies to control the temperature of the electromagnetic components, thereby mitigating heat generated from ohmic resistance, eddy currents, or other electromagnetic heating effects. Effective thermal management is essential for maintaining efficiency, performance, and longevity of the system.

The invention also encompasses a torque distribution system for automatic machines featuring multiple moving parts, each associated with a respective degree of freedom. The torque distribution system is driven by a prime mover supplying rotational power and may include one or more drive shafts, each optimized to operate at different rotational speeds to accommodate various operational requirements.

Each drive shaft within the torque distribution system may be linked to multiple mechanical transmission mechanisms, each connected to a corresponding moving part associated with a specific degree of freedom. This configuration allows for precise and adaptable control over each degree of freedom within the system, catering to a wide range of applications.

The invention also provides an electromagnetic actuator that can be easily installed and removed within the torque distribution system of an automatic machine. The torque distribution system includes a support frame that secures the output from a prime mover, supplying rotational power to a drive shaft. The mechanical transmission medium—whether a cable, belt, or another method—is connected to a movable part associated with a degree of freedom, facilitating controlled actuation.

The present invention introduces a novel and efficient actuation and power distribution system tailored for machine automation and robotics. By utilizing electromagnetic fields in conjunction with a unique three-body configuration, this invention delivers precise control, reduces system complexity, and enhances energy efficiency. Its modular and adaptable design ensures optimal performance across a wide range of applications—from industrial machinery to prosthetics. This invention represents a significant advancement over existing technologies, addressing shortcomings of conventional systems, and unlocking new possibilities in the fields of automation and robotics.

### BRIEF DESCRIPTION OF DRAWINGS

FIG. 1 is a schematic representation of an electrical machine of the prior art.

FIG. 2 is a schematic representation of present invention.

FIG. 3 is a schematic representation of present invention where a stack of actuators is connected via a common shaft.

FIG. 4 is a perspective view of one embodiment of the system according to the present invention shown facilitating the actuation of a robotic hand. Showing just the forearm and hand.

FIG. 5 is a perspective view showing the actuator assembly according to the present invention detailing the tendon ends extending away from a stack of 3 body actuators.

FIG. 6 is a perspective of the frame of FIG. 5 the upper frame removed exposing the stacked actuators.

FIG. 7 Perspective view of the lower cage frame of the actuator assembly according to the present invention as shown in FIG. 5.

FIG. 8 is a perspective exploded view of one embodiment of an actuator.

FIG. 9 is a perspective exploded view of an alternative embodiment of an actuator.

FIG. 10 is a perspective exploded view of another alternative embodiment of an actuator.

FIG. 11 is a perspective exploded view of another alternative embodiment of an actuator.

FIG. 12 is a side view of the embodiment of an actuator from FIG. 5 with cut away showing the inner components.

FIG. 13 is a back view of the embodiment of an actuator from FIG. 5.

FIG. 14 is a Section view of the embodiment of an actuator from FIG. 12.

FIG. 15 is a Detail of cutaway view of the embodiment of an actuator from FIG. 12.

FIG. 16 is a Side view of tendon actuated finger showing going from extension to flexation.

FIG. 17 is a System control schematic of an embodiment of an actuator generating flexation of a finger.

FIG. 18 is a System control schematic of an alternative embodiment of an actuator generating flexation of a finger.

FIG. 19 is a schematic view of an alternative embodiment of a generator configuration not including the frame or bulkhead.

### DETAILED DESCRIPTION OF THE INVENTION

The accompanying drawings, which are incorporated and constitute a part of this disclosure, illustrate various embodiments of the present invention. The drawings are intended to represent the invention's unique aspects and may include representations of proprietary technology developed by the applicant. Additionally, these drawings may contain trademarks and copyrights belonging to the applicant. Any third-party marks present are used for illustrative purposes only. All rights to the trademarks and copyrights represented in these drawings, except those belonging to their respective owners, are vested in and remain the property of the applicant. The applicant retains all rights in these trademarks and copyrights, and permission is granted to reproduce the material solely in connection with the granted patent and for no other purpose.

As a further preliminary matter, it will be readily understood by one having ordinary skill in the relevant art that the present disclosure has broad utility and application, particularly in the field of actuation systems for robots and automatic machinery. Any embodiment of the invention may incorporate one or more of the disclosed aspects and features. Furthermore, any embodiment identified as “preferred” is considered part of the best mode contemplated for carrying out the present invention.

Other embodiments may be discussed for additional illustrative purposes to provide a full and enabling disclosure. Many embodiments, such as adaptations, variations, modifications, and equivalent arrangements, are implicitly disclosed by the embodiments described herein and fall within the scope of the present disclosure.

Accordingly, while embodiments are described herein in detail in relation to one or more specific embodiments, it is to be understood that these disclosures are illustrative and exemplary of the present invention. They are made merely for the purposes of providing a full and enabling disclosure and are not intended to limit the scope of the patent protection afforded in any claim of a patent issuing herefrom, which scope is defined by the claims and the equivalents thereof.

It is not intended that the scope of patent protection be defined by reading into any claim a limitation found herein that does not explicitly appear in the claim itself. For example, any sequences or temporal order of steps of the various processes or methods described herein are illustrative and not restrictive.

Accordingly, although the steps of various processes or methods may be shown and described in a specific sequence or temporal order, they are not limited to being carried out in any particular sequence or order unless otherwise indicated. The steps in such processes or methods may generally be carried out in various sequences and orders while still falling within the scope of the present invention.

The scope of patent protection is intended to be defined by the issued claims rather than the description set forth herein. Each term used herein refers to what an ordinary artisan would understand based on the contextual use of such a term within the present disclosure. To the extent that the meaning of a term differs in any way from any particular dictionary definition, it is intended that the meaning as understood by the ordinary artisan shall prevail.

Furthermore, as used herein, “a” and “an” each generally denote “at least one,” but do not exclude a plurality unless the context clearly dictates otherwise. When used herein to join a list of items, “or” denotes “at least one of the items,” but does not exclude a plurality of items. Finally, when used to join a list of items, “and” denotes “all of the items of the list.” The following detailed description refers to the accompanying drawings.

While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. The following detailed description does not limit the disclosure; instead, the proper scope is defined by the appended claims. The present disclosure includes headings for reference purposes only and should not be construed as limiting the subject matter disclosed under the headings. The present disclosure covers many aspects and features. Although many aspects and features relate to methods, systems, apparatuses, and devices for actuating robots and automatic machines using a capstan actuator with composite control coil, embodiments of the present disclosure are not limited to use only in this context.

### LIST OF REFERENCED ELEMENTS

Wherever possible, the same reference numbers are used in the drawings and the following description to refer to the same or similar elements. Accordingly, wherever possible, the following reference numbers are adhered to within the specification to refer to the corresponding referenced elements within the drawings of the present application.

| Referance | |
|---|---|
| Number | Term |
| 1 | ROBOTIC TENDON ACTUATED ARM |
| 10 | HAND (PRIOR ART) |
| 20 | FINGER (PRIOR ART) |
| 21 | KNUCKLE OF FINGER (PRIOR ART) |
| 22 | FIRST DIGIT OF FINGER (PRIOR ART) |
| 23 | SECOND DIGIT OF FINGER (PRIOR ART) |
| 24 | THIRD DIGIT OF FINGER (PRIOR ART) |
| 25 | FINGER JOINT (PRIOR ART) |
| 26 | FINGER TENDON LINE GUIDES (PRIOR ART) |
| 30 | TARGET OBJECT TO GRASP |
| 100 | ROTOR |
| 100a′ | ALTERNATIVE EMBODIMENT OF EDDY CURRENT ROTOR DRUM WITH VENTING CHANNELS |
| 100b′ | ALTERNATIVE EMBODIMENT OF EDDY CURRENT ROTOR DRUM WITHOUT VENTING CHANNELS |
| 100b″ | ALTERNATIVE EMBODIMENT OF EDDY CURRENT ROTOR DRUM WITHOUT VENTING CHANNELS |
| 100b″′ | ALTERNATIVE EMBODIMENT OF EDDY CURRENT ROTOR DRUM WITHOUT VENTING CHANNELS |
| 100c | ALTERNATIVE EMBODIMENT OF GENERATOR DRUM |
| 101 | MALE TAPERED COUPLING THREAD |
| 102 | FEMALE TAPERED COUPLING THREAD |
| 103 | AIR COOLING FINS |
| 104 | SPLIT THREADS |
| 105 | COOLING AIR VENTS |
| 106 | SUPPLIED COOLING AIR |
| 107 | CHANNELED COLLING AIR |
| 110 | GENERATOR COIL CIRCUIT |
| 111 | PICK UP COIL |
| 112 | DRIVE COIL |
| 200 | STATOR |
| 200a′ | ALTERNATIVE EMBODIMENT OF STATOR WITH SALIENT POLES |
| 200a″ | ALTERNATIVE EMBODIMENT OF STATOR WITH SALIENT POLES |
| 200a″′ | ALTERNATIVE EMBODIMENT OF STATOR WITH SALIENT POLES |
| 200b | ALTERNATIVE EMBODIMENT OF STATOR WITH CLAW POLES |
| 201 | STATOR BEARINGS |
| 211 | EXCITATION COIL |
| 212 | OUTPUT COIL |
| 250 | OUTPUT TORQUE OF STATOR |
| 251 | TENDON SPOOL |
| 253 | TENDON ATTACHMENT POINT |
| 254 | SUN GEAR |
| 255 | DRIVER BELT PULLY |
| 256 | TENDON WRAPPING AROUND SPOOL |
| 300 | ULTIMATE FRAME OF SYSTEM THAT THE ACTUATOR WORKS AGAINST |
| 310 | LOWER CAGE FRAME |
| 311 | DRIVE SHAFT BEARING BULKHEADS |
| 312 | OPENING IN CAGE FRAME ALLOWING VENTILATION |
| 313 | BULKHEAD FOR MOUNTING PRIME MOVER |
| 314 | CAGE FRAME TENDON GUIDE |
| 315 | UPPER CAGE FRAME |
| 320 | BULKHEAD MOUNTING POINTS ON CAGE FRAME |
| 350 | WIRE GUIDE BULKHEAD |
| 350a′ | ALTERNATIVE EMBODIMENT OF WIRE GUIDE BULKHEAD WITH CLOCKSPRING CONNECTION |
| 350b | ALTERNATIVE EMBODIMENT OF WIRE GUIDE BULKHEAD WITH BRUSH CONTACTS AND OPEN GEOMETRY |
| 351 | WIRE GUIDE BUSHINGS |
| 352 | INNER WIRE GUIDE BULKHEAD |
| 352a′ | ALTERNATIVE EMBODIMENT OF INNER WIRE GUIDE BULKHEAD WITH CLOCKSPRING CONNECTION |
| 352b | ALTERNATIVE EMBODIMENT OF INNER WIRE GUIDE BULKHEAD WITHOUT POWER CONNECTION |
| 352c | ALTERNATIVE EMBODIMENT OF INNER WIRE GUIDE BULKHEAD WITH BRUSH CONTACTS AND OPEN GEOMETRY |
| 353 | OUTER WIRE GUIDE BULKHEAD |
| 353a′ | ALTERNATIVE EMBODIMENT OF OUTER WIRE GUIDE BULKHEAD |
| 353b | ALTERNATIVE EMBODIMENT OF OUTER WIRE GUIDE BULKHEAD |
| 353c | ALTERNATIVE EMBODIMENT OF OUTER WIRE GUIDE BULKHEAD WITH OPEN GEOMETRY |
| 356 | FRAME MOUNTING POINTS |
| 357 | OPENING FOR REMOVAL |
| 360 | COMMUNICATOR BULKHEAD |
| 360a | ALTERNATIVE EMBODIMENT OF COMMUNICATOR BULKHEAD SUPPORTING RING GEAR AND BRUSH CONTACTS |
| 360b | ALTERNATIVE EMBODIMENT OF COMMUNICATOR BULKHEAD WITH BRUSH CONTACTS |
| 400 | DRIVE SHAFT |
| 450 | TORQUE ON SHAFT |
| 460 | PRIME MOVER |
| 490 | PRIME MOVER RPM |
| 500 | MECHANICAL OUTPUT FROM STATOR TO FRAME |
| 510 | TENDON OUTPUT |
| 511 | PULLING END OF TENDON |
| 512 | TENDON END EFFECTOR CONNECTION |
| 520 | TOOTHED BELT |
| 521 | DRIVEN BELT PULLY |
| 530 | PLANETARY GEAR ASSEMBLY |
| 531 | RING GEAR |
| 532 | PLANETARY GEARS |
| 533 | CARRIER |
| 534 | CARRIER BEARING |
| 550 | MECHANICAL DAMPENER |
| 600 | ACTUATOR |
| 600a′ | ALTERNATIVE EMBODIMENT OF ACTUATOR |
| 600a″ | ALTERNATIVE EMBODIMENT OF ACTUATOR |
| 600b′ | ALTERNATIVE EMBODIMENT OF ACTUATOR WITH CLOCKSPRING POWER CONNECTION |
| 600b″ | ALTERNATIVE EMBODIMENT OF ACTUATOR WITH CLOCKSPRING POWER CONNECTION |
| 600b″′ | ALTERNATIVE EMBODIMENT OF ACTUATOR WITH CLOCKSPRING POWER CONNECTION |
| 600b″″ | ALTERNATIVE EMBODIMENT OF ACTUATOR WITH CLOCKSPRING POWER CONNECTION |
| 600c | ALTERNATIVE EMBODIMENT OF ACTUATOR WITH PLANETARY GEARBOX |
| 600d | ALTERNATIVE EMBODIMENT OF ACTUATOR WITH DRIVE BELT OUTPUT |
| 600e | ALTERNATIVE EMBODIMENT OF ACTUATOR WITH GENERATOR CONFIGURATION |
| 700 | ELECTRIC FIELD BETWEEN THE ROTOR AND STATOR |
| 700a | ELECTRIC FIELD BETWEEN THE STATOR EXCITATION COIL AND ROTOR PICKUP COIL |
| 700b | ELECTRIC FIELD BETWEEN THE ROTOR DRIVE COIL AND STATOR OUTPUT COIL |
| 701 | ACTUATOR POWER/CONTROL SIGNAL |
| 702 | GROUND OR COMMON ELECTRICAL SLIP RING |
| 703 | GENERATOR ELECTRICAL OUTPUT |
| 710 | CLOCK SPRING FLEX CIRCUIT CONNECTION |
| 711 | CLOCK SPRING FLEX CIRCUIT COVER |
| 720 | DISC SLIP RING |
| 720a | ALTERNATIVE EMBODIMENT OF DISC SLIP RING |
| 720b | ALTERNATIVE EMBODIMENT OF DISC SLIP RING WITH ENCODER |
| 721 | POWER CONTACT RINGS |
| 751 | ROTARY ENCODER |
| 790 | ACTUATOR RPM |
| 800 | ACTUATOR ASSEMBLY |
| 800a | ALTERNATIVE EMBODIMENT OF ACTUATOR ASSEMBLY |
| 900 | SYSTEM CONTROLLER |
| 901 | PRIME MOVER POWER/CONTROL SIGNAL |

The present invention relates to an advanced electromechanical actuator system designed to deliver precise torque control within a compact and modular form factor. This system incorporates a stackable arrangement of electromagnetic actuators, each comprising a rotor and stator pair assembled along a common drive shaft. This design allows for scalable and customizable configurations tailored to meet specific torque and power requirements across various applications, including robotics, industrial automation, and prosthetics.

A key innovation of this invention is the arrangement of the stator, which performs work when the electromagnetic field is activated. The output of this work is proportional to the current supplied to the electrical machine. The rotor maintains a constant rotational speed (RPM), while the stator rotates until equilibrium between its mechanical output and the electromagnetic force is achieved. This configuration enables precise control and understanding of the actuator's force output. When coupled with an encoder, a closed-loop control system can manage both the rate of change in position and the amount of force generated.

Advantageously, the invention utilizes electromagnetic fields to transmit torque between the rotor and stator without physical contact, thereby minimizing wear and reducing maintenance needs compared to traditional friction-based systems. The stackable nature of the actuators, combined with their ability to be independently controlled, allows for systems with multiple degrees of freedom, enhancing both functionality and versatility.

Traditional electromechanical systems—such as motors, servos, and stepper motors—often struggle to replicate the dynamic behavior of biological muscles. Biological muscles can vary force without changing position, relax completely when deactivated, and dynamically adjust to external forces through isotonic and isometric contractions. These natural properties contribute to the efficiency, adaptability, and safety of biological systems, especially in applications involving direct human interaction. In contrast, traditional motors face challenges in achieving force neutrality and compliance, particularly when holding a position. They often require continuous power to maintain position, leading to overheating when the motor stalls. The use of rigid holding mechanisms, such as worm gears or high-ratio gearboxes, while effective at maintaining position without power, inherently sacrifices compliance and increases rigidity, posing potential safety risks in environments where flexibility and adaptability are crucial.

The present invention addresses these challenges by leveraging its innovative design to better mimic the behavior of biological muscles, providing enhanced compliance and adaptability. The design can incorporate various methods for thermal management, such as active air cooling, to maintain optimal performance and extend the system's lifespan. Furthermore, alternative electrical machines, such as generators, can be integrated to recapture power inputs, thereby increasing overall system efficiency. The rotational output torque of the device can be harnessed through various mechanical configurations—including gearing, linkages, pulleys, and rack-and-pinion systems—to either amplify torque or convert angular displacement into linear motion, depending on application requirements.

### Overview of the Invention's Configuration

The advanced electromechanical actuator system is designed for precise torque control and efficient mechanical work generation in a compact and modular form. The system leverages the interaction between a rotor and a stator, uniquely configured to harness electromagnetic forces for various applications, including but not limited to robotics, industrial automation, and prosthetics.

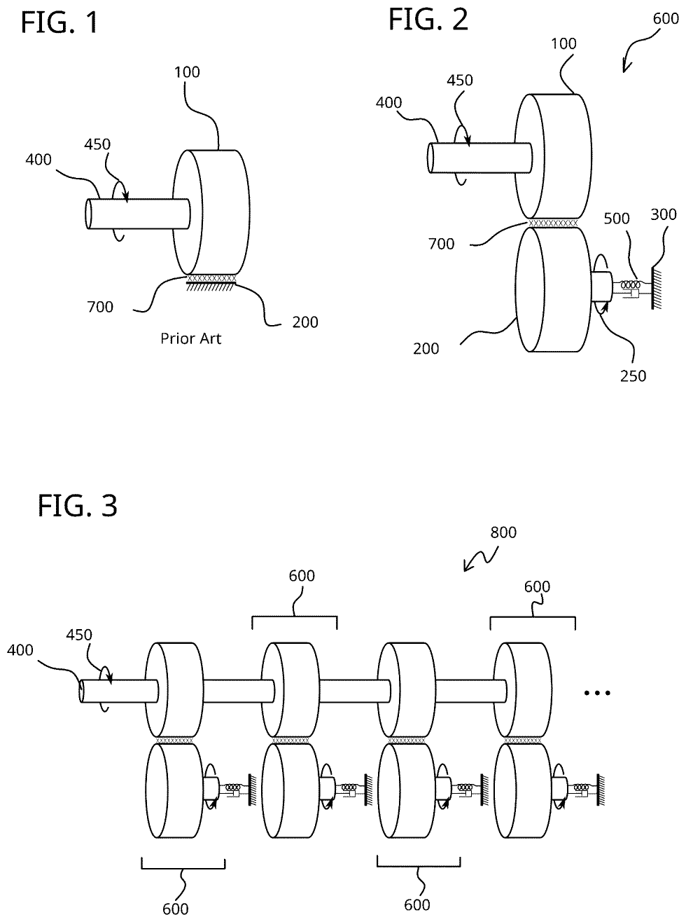

Referring to FIG. 1, prior art in the form of a free-body diagram of a traditional electrical machine is illustrated. In such devices, the rotor 100 is mounted on an drive shaft 400 and interacts with the stator 200 through an electromagnetic field 700. In this simplified diagram, the stator 200 is depicted as a grounded element on one side of the rotor 100. In practice, rotors and stators are concentric to each other and interact either axially or radially, with the stator being fixed to a frame. This interaction generates a torque 450, either as an output force, as observed in servos, or as a braking force, as in generators. The reaction forces produced by the stator in response to the electromagnetic interaction are typically transmitted directly to the frame of the device through fixed mounts.

In the context of actuation, the rotor 100 rotates to drive the end effector into the desired position by generating torque through the electromagnetic interaction 700 between the rotor 100 and the stator 200. Once the intended position is reached, the system must maintain this position. In such cases, while the rotor 100 ceases rotation, the armature remains powered to sustain the electromagnetic field 700, leading to challenges such as continuous power consumption and thermal management issues. Additionally, the requirement for simulated compliance to adjust to external forces affects the system's adaptability and efficiency, particularly in dynamic environments.

### Torque-Current Relationships in Electrical Machines

Electrical machines exhibit torque-current relationships that can be modeled as either linear or quadratic. Understanding these relationships is essential for optimizing actuator performance.
Linear Relationships: Found in direct current (DC) motors, permanent magnet synchronous motors (PMSMs), and brushless DC motors (BLDCs).
Quadratic Relationships: Found in induction motors, eddy current brakes, and reluctance motors, including switched reluctance motors (SRMs).

In DC motors, particularly in series and shunt configurations, the torque T produced by the rotor is directly proportional to the armature current Iₐ:

$$T = k \cdot Ia$$

where k is a constant determined by factors such as the number of windings, magnetic flux, and the physical dimensions of the motor.

In synchronous machines, including synchronous generators and motors, the torque T is similarly proportional to the stator current Is, assuming operation within the linear region:

$$T = k \cdot Is \cdot cos θ$$

Where θ represents the angle between the stator and rotor magnetic fields.

In PMSMs and BLDCs, the torque T is directly proportional to the current I through the windings:

$$T = k \cdot I$$

In contrast, induction motors exhibit a quadratic relationship between torque T and rotor current Iᵣ, particularly under slip conditions where the rotor speed ωᵣ deviates from the synchronous speed ωₛ:

$$T = k \cdot {Ir}^{2} \cdot Δω$$

Where Δω=ωs−ωr.

In eddy current brakes, the braking torque T is proportional to the square of the magnetic flux density B, which is proportional to the current I supplied to the electromagnets:

$$T = {k}^{′} \cdot {I}^{2} \cdot Δω$$

In reluctance motors, including SRMs, the torque T depends on the square of the current I:

$$T = k \cdot {I}^{2} \cdot sin ( 2 θ )$$

Where θ is the rotor position angle relative to the stator field.

### Selection of Electrical Machines for the Invention

While the simplified formulas illustrate the fundamental relationships, the complexity of electrical machine construction influences their suitability for specific applications. Certain configurations are better suited as embodiments of the present invention than others.
Eddy Current Brakes: Ideal for smaller actuators due to simplicity and efficiency. Coils are located on the stator, which rotates only to a limited degree, requiring only a simple direct current (DC) power supply.
Generators: Suitable for larger devices where increased construction complexity can be accommodated. Regenerative braking provides robust output torque and recovers input energy, enhancing overall system efficiency.
Permanent Magnet Machines: Face issues with cogging torque when inactive, introducing unwanted torque during disengagement.

Larger devices can better accommodate increased construction complexity, making electrical machines like generators more viable. Regenerative braking not only provides robust output torque but also recovers some input energy, further improving system efficiency.

### Innovative Configuration of the Invention

Referring to FIG. 2, the novel approach of the current invention is illustrated, presenting an actuator 600 where the stator 200 is allowed to rotate independently from the rotor 100. In the free-body diagram, the stator 200 is shown on a separate axis, interfacing with the rotor 100 through the electromagnetic field 700. In practice, the rotor 100 and stator 200 are concentric, with the electromagnetic field 700 interacting along the boundary between them.

Unlike traditional systems where the stator is fixed to the frame, this invention allows the stator to rotate independently from both the frame and the rotor. The rotor is driven in steady rotation by an external prime mover 460, providing an input torque 450 to the drive shaft 400. When the stator 200 is energized, the electromagnetic field 700 is generated between the rotor 100 and stator 200, causing the stator to begin rotating with the rotor, producing an output torque 250.

By enabling the stator to rotate, the system harnesses the reaction force generated by the electromagnetic interaction to perform mechanical work, such as actuation. This innovative approach transforms the reaction forces on the stator (previously constrained within the frame) into useful mechanical output, expanding the functionality of traditional electrical machines.

The electrical machine in the current invention functions similarly to a traditional two-element device, generating torque through the interaction between the rotor 100 and stator 200. However, in conventional systems, motion is induced by the stator turning the rotor. In this invention, the drive shaft 400 and rotor 100 maintain constant rotation, while the stator 200 extracts torque from its interaction with the rotor via the electromagnetic field 700. The stator then transmits this torque 250 to generate the motive force for actuation. The stator's ability to rotate independently of the frame 300 allows the torque to be transferred to a mechanical output 500, significantly enhancing the actuator's functionality.

### Operational States of the Invention

The system operates in distinct states, determined by the presence and magnitude of the electromagnetic field:
Resting State: With no electromagnetic field applied, the rotor 100 spins constantly at a fixed RPM, and the stator 200 remains fully compliant—capable of rotating without resistance. There is no interaction between the rotor and stator, allowing both components to move independently.
Powered State: When powered, an electromagnetic field 700 is generated proportional to the applied current. The stator 200 begins to rotate with the rotor 100 as the electromagnetic force couples them together. The stator's behavior is determined by the external torque applied by forces 500, such as those exerted by an end effector or mechanical loads. The stator will adjust its rotation based on the balance between electromagnetic torque and external torque. When the forces 500 are less than the induction forces from the electromagnetic field the stator will rotate in with the rotor, when they are greater, the stator will rotate counter to the rotor, and when they are equal, the stator will stop rotation relative to the frame.

This dynamic enables the system to manage varying load conditions safely, maintaining precise control over the force exerted by the stator 200. Except for brief transitional moments, the angular velocity difference between the rotor 100 and stator 200 remains constant, ensuring stable operation and predictable performance. In the translational moments, the relative rotational velocities of the rotor and stator get closer, reducing the ultimate force that can be generated. This design preserves compliance and precise control across a wide range of operating conditions, making it particularly suitable for applications requiring adaptive responses to external forces. Additionally, the rotor's continuous rotation aids in convective cooling of the assembly, enhancing efficiency and extending the system's lifespan.

### Preferred Embodiments and Control Variables

One preferred embodiment incorporates an eddy current brake electrical machine due to its simplicity, compactness, and efficiency. This design ensures that even when the rotor 100 is rotating, the actuator remains free of unwanted torque when disengaged, enhancing control precision. For larger embodiments, a generator-type electrical machine may be more suitable for recapturing energy, further improving system efficiency.

The output force 250 generated by the actuator can be precisely calibrated by controlling key operational variables, depending on the specific type of electrical machine used. The relationship between current and torque is crucial in achieving the desired performance, whether during steady-state operations or dynamic tasks. Fine-tuning these variables enables the system to maintain consistent, reliable performance, adapting to various operational scenarios.

In the case of an eddy current brake, two primary variables-rotor 100 speed relative to the stator 200 and stator current—are controlled to manage the output force 250. The compliance introduced by the rotating stator allows for dual-variable control, enhancing the system's capability. The rotor's speed directly influences the induced eddy currents and, consequently, the braking force. Lower speeds can be employed when less force is required, leading to energy savings, while higher speeds can be utilized when more power is needed. Simultaneously, adjusting the current to the stator fine-tunes the magnetic field strength 700, thereby affecting the braking torque. This precise calibration ensures that the actuator delivers the required force while maintaining safe and compliant operation. Feedback mechanisms, such as rotational speed and current sensors, can be integrated to monitor and adjust these variables in real time, ensuring optimal force levels and compliance throughout the system's operation.

### Modular and Stackable Configuration

Referring to FIG. 3, the modular, stackable configuration of the actuator assembly 800 is illustrated, where multiple actuators 600 are arranged along a common drive shaft 400. Each actuator operates independently, utilizing the torque 450 provided by an external prime mover 460 to generate output force 250. This stackable design enables the system to support multiple degrees of freedom and scalable actuation, making it well-suited for controlling numerous independent actuation points within a compact space. The modularity enhances adaptability and precision in complex environments, such as multi-degree-of-freedom robotic limbs or advanced industrial machinery, where each actuator can be finely tuned to meet specific torque and power requirements.

Following these foundational concepts illustrated in FIGS. 1-3, the subsequent figures explore various possible embodiments of the invention. These embodiments consider different rotor and stator geometries, mechanical connections, power transmission methods, and control methodologies, providing a comprehensive overview of the system's versatility.

### Application in Robotic Systems

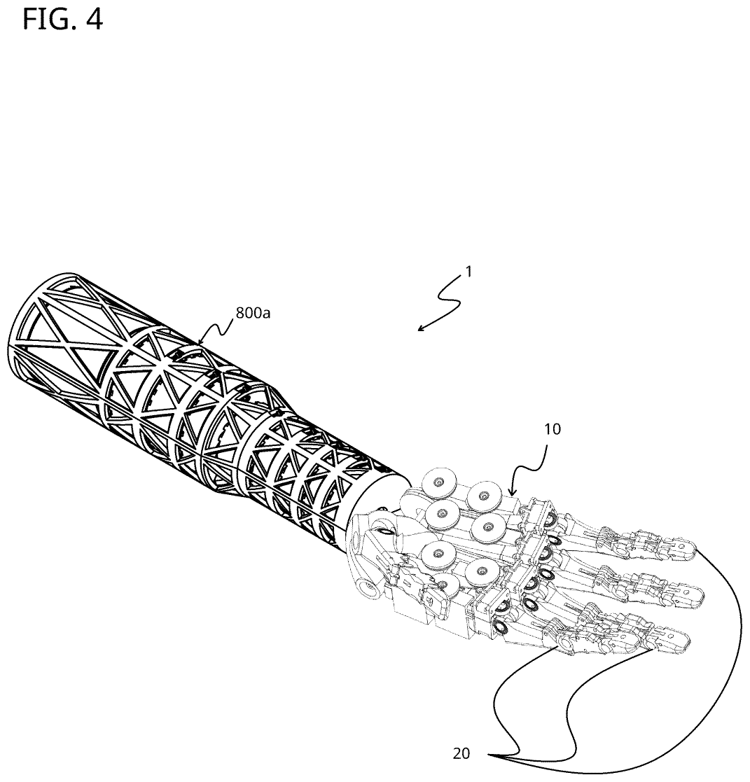

In FIG. 4, the actuator system 800a is integrated into a robotic forearm and hand assembly, illustrating how the invention can be applied to controlling complex robotic mechanisms. The robotic hand 10 and fingers 20 depicted are based on prior art designs, where individual finger movements are typically driven by tendon-like mechanisms. In traditional systems, the actuation required for such movements relies on independent actuators for each finger or joint, leading to a bulky and less efficient design.

By incorporating the modular actuator system 800a into the forearm structure, this invention significantly improves upon the prior art by enabling multiple degrees of freedom in a more compact and efficient form. The actuator system drives the tendon-based movement of the hand and fingers, providing the necessary torque for precise and responsive control. Unlike prior systems, where each actuator was housed separately, the current design allows for multiple actuators to be stacked along a common shaft within the forearm, reducing the overall footprint while enhancing control over intricate movements. This improvement highlights the invention's ability to deliver fine motor control in applications such as prosthetics and advanced robotics, where space efficiency and adaptability are critical.

### Structural Components and Tendon Routing

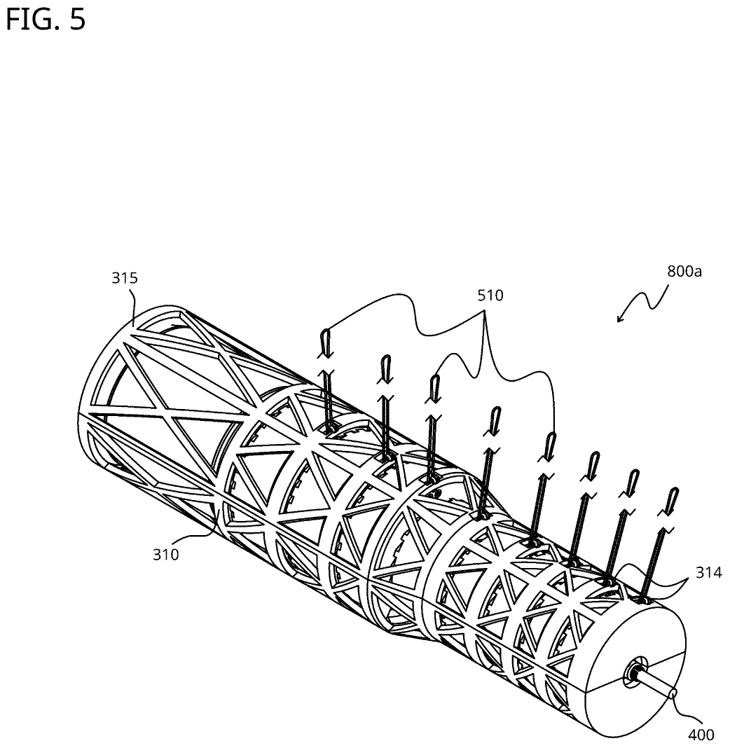

FIG. 5 presents a perspective view of the three-body actuator assembly 800a with the upper cage frame 315 in place, illustrating how tendons 510 are routed through the assembly via tendon guides 314 integrated into the upper cage frame. The tendon guides 314 may incorporate bushings or bearings to reduce sliding friction as the tendons extend or contract. These tendons transmit the output force 250 from the actuator to the point of actuation, such as the joints of a robotic hand or other mechanical components. The upper and lower cage frames 315 and 310 serve as structural supports, reinforcing bulkheads and ensuring the alignment and integrity of the actuator system while facilitating the routing of tendons. The drive shaft 400 runs through the center of the assembly, powering the individual actuators stacked along its length.

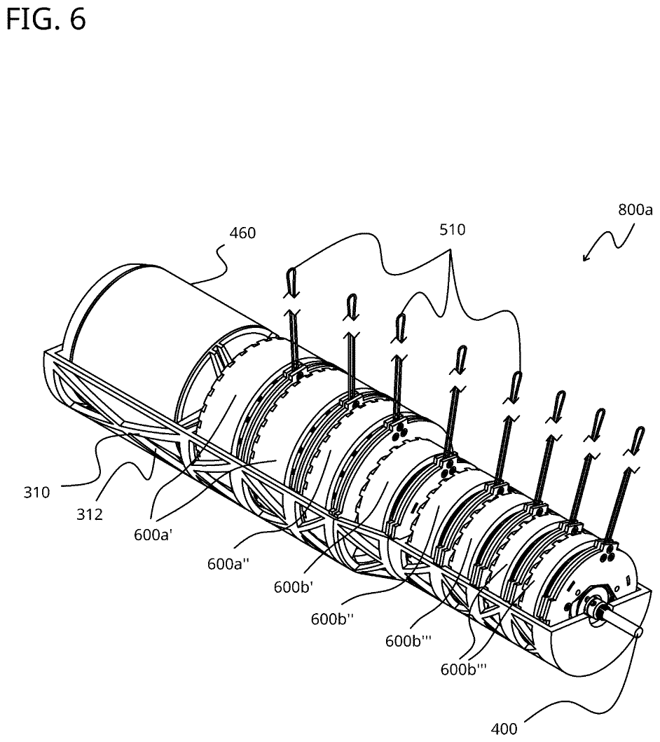

FIG. 6 shows the actuator assembly 800a with the upper cage frame 315 removed, revealing the internal arrangement of various actuator embodiments (600a′, 600a″, 600b′, 600b″, 600b′″) within the system. A prime mover 460 powers the actuator system, driving the central drive shaft 400. Each actuator, mounted along the drive shaft 400, is responsible for controlling tendons 510 that drive mechanical components, such as a robotic hand.

The individual actuators are stacked in a modular arrangement within the lower cage frame 310, allowing for precise control over multiple degrees of freedom. Tendon guides 314 route the tendons out of the frame, ensuring minimal friction during operation. Ventilation openings 312 in the frame provide airflow to cool the actuators, crucial for managing heat and maintaining operational efficiency. This modular design allows the system to be scaled or adjusted for specific force and control requirements, making it adaptable for various robotic and automation applications. The compact nature of the system allows it to control complex, multi-axis movements with high precision while reducing the overall footprint.

### Thermal Management and Structural Integrity

The ventilation openings 312 in the frame are critical for maintaining the efficiency and performance of the actuators. Electrical machines experience a decline in output and efficiency as internal temperatures rise due to increased resistance. In eddy current devices, elevated temperatures reduce the ability to generate counteracting magnetic fields, further diminishing performance. Proper cooling, facilitated by these ventilation openings, is essential for optimal operation.

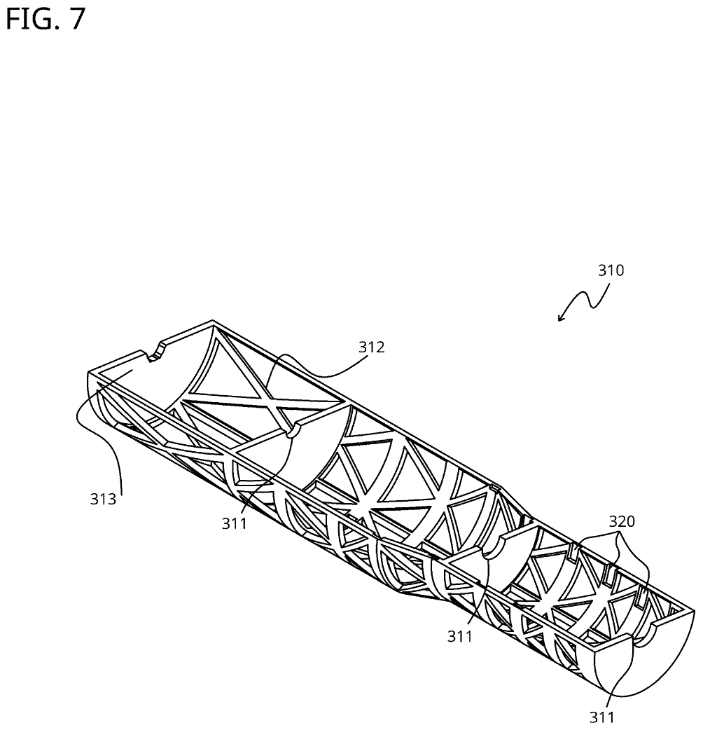

FIG. 7 provides a perspective view of the lower cage frame 310, illustrating mounting points for the prime mover 313 and bearing points for the drive shaft 311. The bulkhead mounting points 320 fix the actuator bulkheads to the frame, providing mechanical stability. This structural integrity is critical for effective actuation, as the frame acts as a foundation against which the actuators develop work. For example, in applications like finger flexion, the frame extends from the bulkhead through the forearm, wrist, and hand up to the knuckle, ensuring that the force generated by the actuator is accurately transmitted to cause finger movement. While the wrist may articulate, the frame must maintain its mechanical stability to ensure efficient and precise force transmission.

Bulkhead mounting points 320 serve as extensions of the frame, securing the actuators and facilitating the routing and mounting of mechanical elements such as line guides, gearboxes, and rack-and-pinion systems. The prime mover mounting point 313 illustrates where the prime mover or other driving components would be secured. Integrating the prime mover into the frame is not necessary, as it can be remotely located, with its output transferred to the drive shaft using any suitable means. Ventilation openings 312 along the frame ensure proper airflow, aiding in heat dissipation to maintain system efficiency during continuous operation.

### Alternative Embodiments and Configurations

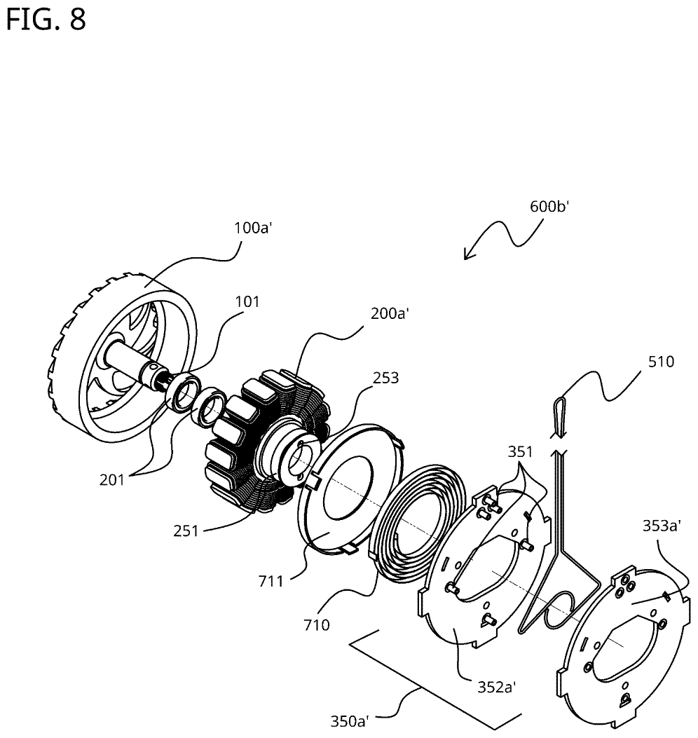

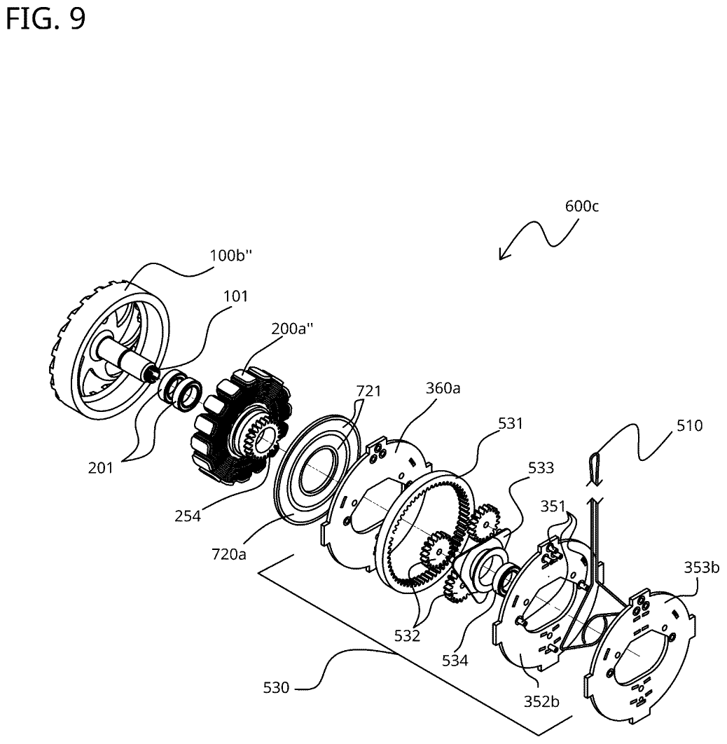

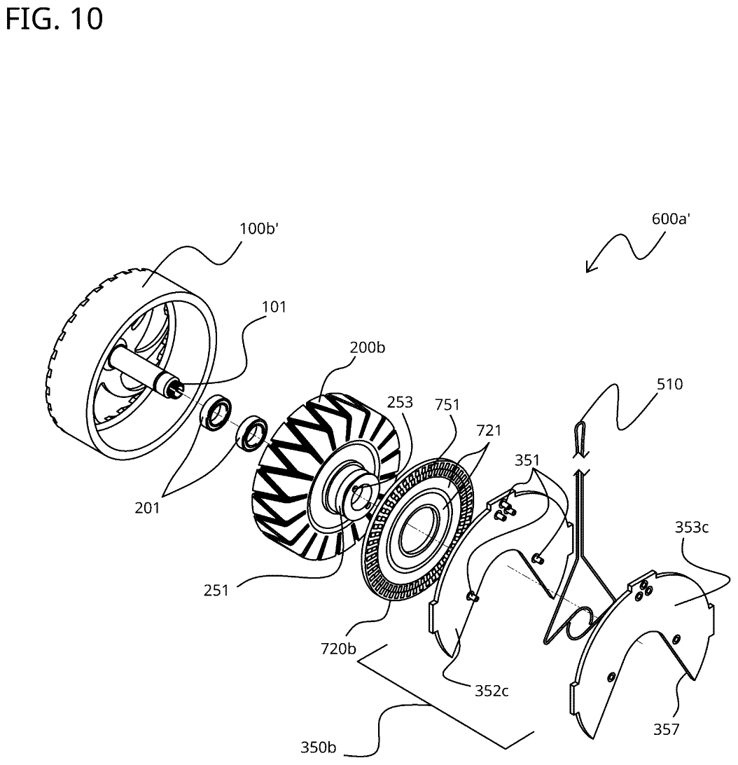

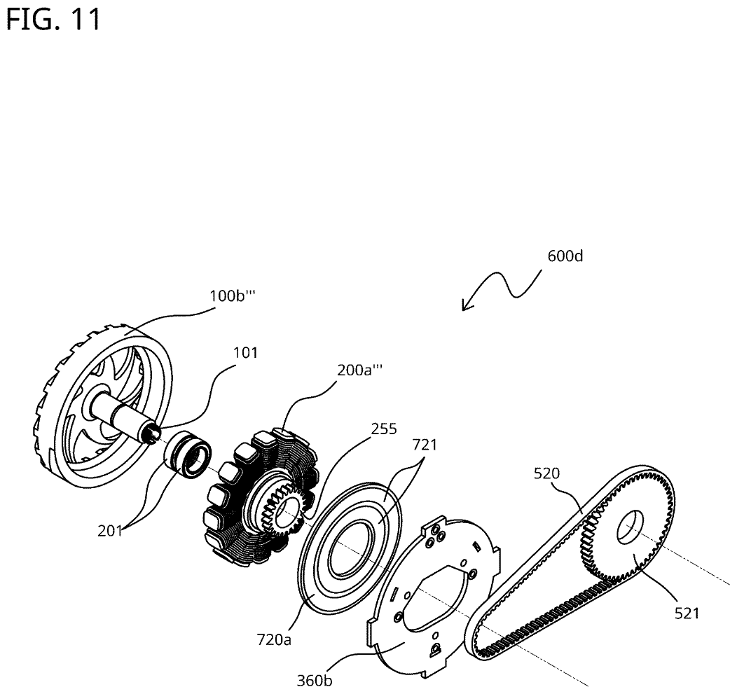

The invention is not restricted to the embodiments described and can be adapted to various configurations. FIGS. 8-11 illustrate several potential embodiments, each utilizing different stator and rotor geometries to optimize performance for specific applications. Variations include:
Clock Spring Circuit: FIG. 8 illustrates the use of a clock spring circuit 710 to transmit power to the stator 200a′ from the wire guide bulkhead 350a′, while other figures depict a slip ring configuration for power transmission.
Planetary Gear System: FIG. 9 highlights a planetary gear system 530 designed to enhance torque output.
Belt Drive Mechanism: FIG. 11 demonstrates the use of a toothed belt for controlled power transmission 255, 520, 521.
Rotary Encoder Integration: FIG. 10 incorporates a rotary encoder 751, along with an alternative construction for the stator 200b.
These embodiments display the invention's broad applicability across various fields and do not represent the full extent of possible configurations.

FIG. 8 presents an exploded view of an alternative actuator embodiment 600b′, showing the internal components and their assembly. The rotor 100a′ is coupled with the stator 200a′, with stator bearings 201 ensuring smooth rotation between the rotor 100a′ and stator 200a′. A tendon spool 251 is integrated into the stator 200a′ to transfer mechanical energy 250 through the attached tendons 510, allowing the actuator to control the movement of an external mechanism. The rotor 100a′ features male tapered coupling threads 101, which, when threaded into the adjacent actuator along the drive shaft 400, generate a clamping force on the drive shaft 400, securely fixing the rotor to the shaft.

The actuator is equipped with a clock spring flex circuit connection 710, which provides power and control signals to the stator from the wire guide bulkhead 350a′. The flex circuit 710 is housed within a clock spring cover 711 to prevent interference with the stator's rotation. The wire guide bulkhead 350a′ is composed of inner 352a′ and outer 353a′ bulkheads that provide structural support and guide the routing of wires and tendons, while also accommodating sensors and controls. Wire guide bushings 351 reduce friction, allowing the tendons to extend and contract with minimal resistance during operation.

FIG. 9 shows an exploded view of another alternative actuator embodiment 600c, featuring a planetary gear system 530 to enhance torque output. The rotor 100b″ is coupled with the stator 200a″, and stator bearings 201 ensure smooth rotation. In this embodiment, the tendon spool 251 has been replaced by a sun gear 254 to facilitate torque transmission 250. The planetary gear system 530, consisting of a ring gear 531, planetary gears 532, and a carrier 533, multiplies the torque output of the stator 200a″. The carrier 533 incorporates the tendon spool for transferring the increased torque to the tendons 510. The ring gear 531 is fixed to the communicator bulkhead 360a and wire guide bulkhead 352b, while the planetary gears 532 and carrier 533 are supported by carrier bearings 534. The system also includes a disc slip ring 720a, which facilitates electrical connections through power contact rings 721 from the communicator bulkhead 360a while allowing independent rotation of the stator.

The primary distinction between rotors 100a′ and 100b″ lies in their geometry, with 100b″ having a larger interaction area, allowing the actuator to generate greater torque. Additionally, rotor 100a′ includes cooling air vents 105, which are absent in rotor 100b″. The difference between the stators is limited to their geometry. Referring to the earlier eddy current brake equation, we can infer that, assuming all other factors remain equal, the constant k′ for actuator 600c is greater than the k′ for actuator 600b′, due to the larger interaction area of rotor 100b″.

The communicator bulkhead 360a and wire guide bulkheads 352b and 353b guide electrical and mechanical connections, ensuring that tendons and wires are properly routed with minimal friction. This configuration is ideal for applications requiring high torque output within confined spaces while maintaining the compact, modular design of the actuator system.

FIG. 10 displays another actuator embodiment 600a′, featuring a larger diameter rotor 100b′ coupled with stator 200b. The rotor is mounted to the drive shaft 400 using tapered coupling threads 101, and the stator is supported by stator bearings 201 for smooth rotation. A tendon spool 251 is integrated into the stator 200a′, transferring mechanical energy 250 through attached tendons 510. This embodiment incorporates a rotary encoder 751 into the disc slip ring 720b, providing precise position feedback for closed-loop control. Electrical connections for powering the stator are routed through power contact rings 721, and sensors for reading encoder data are embedded in the wire guide bulkheads 352c.

The stator in this configuration 200b uses a claw pole design like those found in alternators, contrasting with the salient pole designs of other stators e.g., 200a′, 200a″. The claw pole design provides different magnetic field geometry, advantageous for applications requiring smoother torque output or improved performance at higher rotational speeds. In contrast, the salient pole construction offers distinct magnetic poles that can enhance torque generation at lower speeds, with simpler construction and more direct control of magnetic flux. These varying designs offer flexibility in choosing the best configuration for specific operational requirements, balancing factors like torque, speed, efficiency, and space constraints.

The wire guide bulkheads 352c, 353c, and wire guide bushings 351 ensure smooth tendon movement and proper electrical routing. Bulkhead openings 357 allow easy assembly and disassembly of the actuator for maintenance. This configuration is well-suited for applications requiring precise position feedback and efficient mechanical power transmission in a compact design.

FIG. 11 presents an exploded view of an alternative actuator embodiment 600d featuring a belt-driven output mechanism. The rotor 100b′″ is coupled with the stator 200a′″, and stator bearings 201 ensure smooth rotation. The stator 200a′″ drives a belt pulley 255, which transmits torque to a toothed belt 520, engaging with a driven belt pulley 521. The disc slip ring 720a ensures continuous electrical contact for powering the stator while allowing independent rotation of the stator.

This belt-driven design offers a smooth, efficient method for transmitting torque to external components such as robotic limbs, while maintaining the modularity and compactness of the actuator. Belt drive systems are ideal for applications requiring quieter operation or where space constraints make direct gear-based systems less practical.

The actuator system's versatility lies in its ability to accommodate a wide range of electrical machines, including but not limited to eddy current devices, generator-type machines, and motors with various stator and rotor geometries. Whether employing claw pole or salient pole designs, these configurations provide distinct advantages depending on the application's requirements for torque, speed, and efficiency.

Additionally, the transmission of mechanical output is not restricted to tendons or belts but extends to any suitable means, such as gears, chains, or direct rotational outputs. This flexibility ensures that the invention can be tailored to meet specific operational demands across various fields, from robotics to industrial automation.

The embodiments detailed in FIGS. 8-11 represent conceptual explorations of the system's potential, and the claims should not be limited by the specific configurations illustrated. The invention encompasses any electrical machine configuration and mechanical transmission method capable of achieving the stated objectives, providing a broad platform for future adaptations and refinements.

### Assembly Techniques and Minimizing Lateral Forces

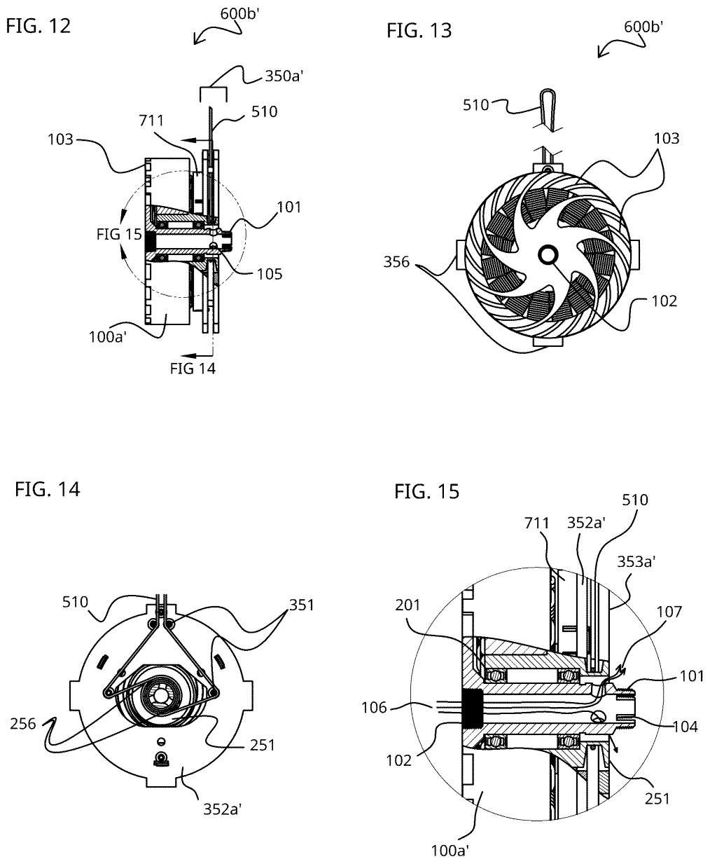

FIGS. 12-15 illustrate the assembly of a specific embodiment 600b′, focusing on the integration of cooling features and the connection of a tendon to a spool. These figures emphasize the importance of proper assembly techniques and the use of bulkheads to minimize lateral forces during operation. Lateral forces on the drive shaft are undesirable as they can cause uneven wear on bearings, increase friction, and lead to component misalignment, reducing the actuator's efficiency and lifespan.

In FIG. 12, a side section view of the actuator 600b′ is shown. Visible details include the rotor 100a′ with its mating tapered threads 101 and 102 as part of the assembly 800a. Each actuator features a male tapered thread that extends past the bulkhead, allowing it to screw into the next actuator's female tapered thread within the stack, creating the necessary clamping force to secure the actuator to the drive shaft 400 not shown. The clock spring cover 711 shields the clock spring flex circuit 710, which provides power and control signals. Also visible are the cooling air vents 105, which direct airflow over the cooling fins 103 of the adjacent actuator in the stack, ensuring the system remains within operational temperature limits during use. The tendon 510, responsible for transmitting force to external mechanical systems, is routed between the two bulkhead elements in the wire guide bulkhead 350a′.

FIG. 13 provides a back view of the actuator, highlighting the cooling fins 103 and the female thread coupling responsible for clamping the actuator onto a common drive shaft 400 not shown. The cooling fins provide convective cooling to the rotor 100a′ and stator 200a′. Additionally, the actuator is shown with bulkhead mounting points 356 for connecting it to the larger structural frame. The tendon 510 is visible, routed through the upper bulkhead mounting point 356.

FIG. 14 provides a cross-sectional view from FIG. 12 of the actuator, highlighting the tendon spool 251 and tendon routing 510 through the wire guide bushings 351, which minimize friction and facilitate smooth tendon movement. The wire guide bushings 351 are positioned on the wire guide bulkhead 352a′ in a manner that cancels out lateral forces, preventing the tendon spool 251 from being pulled to one side. This type of mechanical connection results in a force couple, where a system of forces imparts angular momentum but no linear momentum. The tendon wrapping 256, illustrated as being routed from both the left and right sides of the spool, ensures that equal force is applied from both directions. This arrangement helps prevent excessive side forces on the drive shaft 400, allowing for more actuators to be supported between the drive shaft support points 311 on both the upper 315 and lower frame 310.

FIG. 15 presents an enlarged breakaway section view of FIG. 12, detailing the male 101 and female 102 tapered coupling threads. The male thread features cuts 104, which enhance its clamping ability against the drive shaft. The stator 200a′ is connected to the rotor 100a′ sleeve via bearings 201, ensuring smooth rotation. A hollow drive shaft 400 not shown may be employed to enable forced air 106 to flow through the center of the axle and exit through ports 107, directing airflow over the cooling fins 103 of adjacent actuators. The compact arrangement of components, including the wire guide bulkheads 352a′ and 353a′, along with the clock spring flex circuit cover 711 (which houses the clock spring circuit 710), ensures efficient operation of both mechanical and electrical elements, enhancing the system's overall durability and robustness.

### Control Methodologies

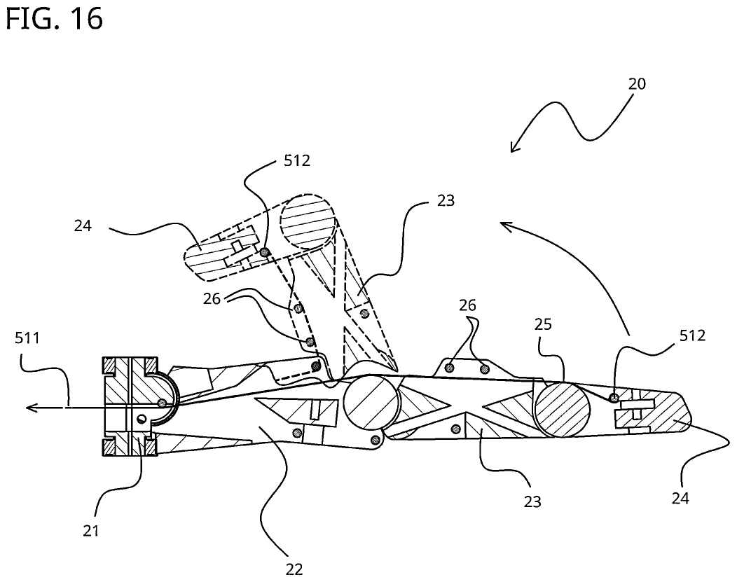

FIGS. 16-18 illustrate control methodologies for an actuator-driven tendon system, applied in a hypothetical use case involving a tendon-actuated finger 20. In this example, the actuator system is employed to control the finger's flexion, allowing it to grasp an object 30. The tendon 510 transmits mechanical energy from the actuator to the finger, enabling precise control over its movement. This example serves as a demonstration of how the actuation system could be utilized to control intricate movements in robotic hands or similar mechanical systems.

In FIG. 16, the mechanical function of a tendon-actuated finger 20 from prior art is illustrated, specifically showing the finger moving from extension to flexion states. The finger consists of three distinct digits: the first digit 22, second digit 23, and third digit 24, connected via finger joints 25. Tendons are routed through finger tendon line guides 26, ensuring proper tension across the knuckles. Tendon 511 is responsible for flexing the finger 20 by shortening the path length between the knuckle 21 and its ultimate mounting point 512. As the tendon pulls, it causes the digits to bend toward each other, producing flexion. The knuckle serves as the base for the actuation mechanism, while each segment follows the motion induced by the tendon.

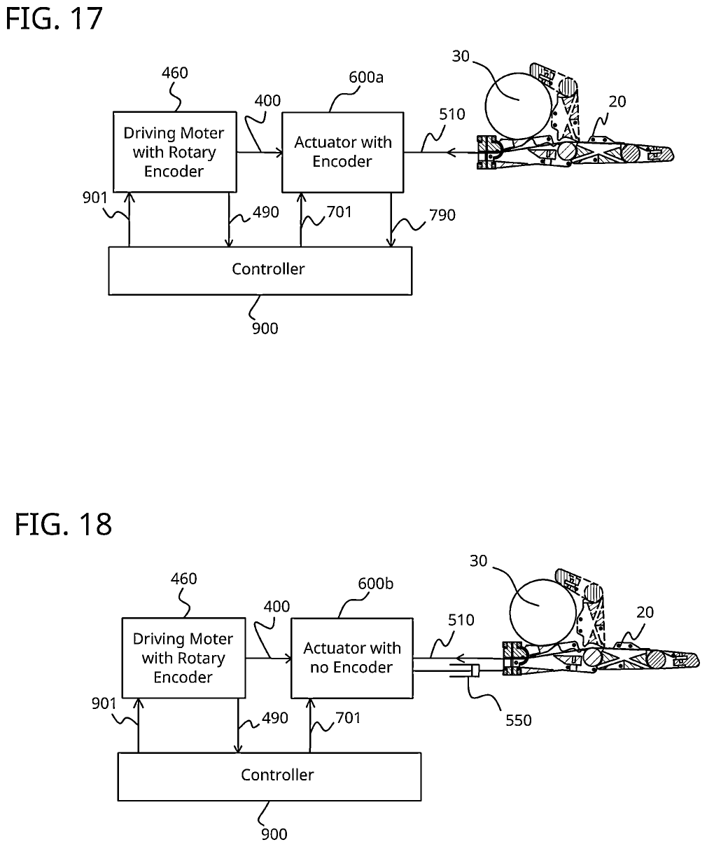

In FIG. 17, a system schematic is shown for controlling an actuator with an encoder 600a connected to a tendon-actuated finger 20 from prior art. The system includes a prime mover 460 equipped with a rotary encoder 490, which powers the drive shaft 400. Both the prime mover and the actuator provide feedback to the system's controller 900. Signals from the rotary encoder 490 on the prime mover and the actuator encoder 790 are sent to the controller, allowing real-time monitoring and adjustment of the system's performance. The tendon 510 transmits force from the actuator to the finger, enabling precise control of the finger's movement. The controller 900 uses feedback from both the prime mover and actuator encoders to ensure accurate position and force control. Each actuator can be calibrated to map the input current and rotor velocity 490 to a precise output torque based on the established relationships for the electrical machine employed. Feedback from the actuator's rotary encoder 790 enables precise positioning and movement of the finger 20, allowing the system to adjust the output force based on real-time measurements.

In FIG. 18, a variation of the previous system is shown, this time with an actuator 600b that does not include an encoder. Like the system in FIG. 17, the driving prime mover 460 powers the drive shaft 400, and the prime mover's rotary encoder 490 provides rotational velocity feedback to the controller 900. However, in this configuration, the system lacks a dedicated encoder on the actuator, meaning the controller can only determine the amount of force provided to the finger 20 without being able to measure position or velocity. Instead of the encoder, the system incorporates a mechanical dampener 550 to regulate the actuation speed and ensure smooth motion. The tendon 510 transmits force to the finger, and the controller 900 adjusts the prime mover's output to ensure the finger moves according to the control inputs. This configuration offers a simpler, more cost-effective alternative while maintaining functional control, though with reduced precision compared to the encoder-equipped version.

In the encoder-equipped system FIG. 17:
Force is applied to the tendon until the desired change in position is detected, with the possibility of using antagonist forces if necessary to assist in movement.
If the system stalls unexpectedly, the controller determines whether to increase the applied force, maintain the current force, or relax the system, based on real-time data from the encoder.
If the stall occurs at the expected contact of the object a calibrated grasping force can be applied that was determined to insure no slipping of the object.
Once the force application is complete, the system can either relax the actuator or work isotonically with a retraction mechanism to return the finger 20 to its original position at the desired speed.

The use of real-time feedback from the actuator encoder ensures a high level of control over the finger's movement, allowing for adaptive force adjustments based on external factors such as the resistance from the object 30 being held. This level of precision makes the system ideal for applications requiring exact positioning and controlled force output.

In the system without an encoder FIG. 18:
A set translation force is applied to change the position of the finger 20, with the possibility of using a mechanical dampener 550 to regulate the maximum rate of movement.
After applying lower translation force for a specified duration, the system adjusts the force to a pre-calibrated grasping force level.
Once the need for force application is complete, the system allows the actuator to relax, reducing the applied force to zero.

Although this method lacks the precision of an encoder-based system, it provides a cost-effective alternative while still delivering reliable force control. The inclusion of a mechanical dampener helps regulate the speed of the finger's movement, ensuring smooth operation despite the absence of direct positional feedback. The simpler configuration may be suitable for applications where less precision is required or where cost and complexity must be minimized.

### Quantitative Analysis of Force Control in Eddy Current Actuators

To provide a practical understanding of how force output varies with changes in rotational speed and current in an eddy current actuator, a quantitative analysis is presented. This analysis includes real-world examples that demonstrate the relationship between these variables, thereby aiding in the design and control of the actuator system. The mathematical models herein assume simplified geometric configurations and idealized dynamic conditions. In practical applications, complex geometries and transient behaviors may necessitate additional considerations and empirical adjustments to achieve accurate performance predictions.

The torque T produced by an

$$T = {k}^{′} \cdot {I}^{2} \cdot ω$$

can be estimated by the following equation:

$$T = {k}^{′} \cdot {I}^{2} \cdot ω$$

where:
T is the torque (Nm).
k is a constant that depends on the geometry of the system and material properties.
I is the current supplied to the stator coil (A)
ω is the relative angular velocity between the rotor and stator (rad/s).

The constant k′ encapsulates factors such as the effective area A of interaction, the electrical conductivity u of the rotor material, and the dimensions of the air gap between the rotor and stator. It can be approximated as:

$$k = a \cdot σ \cdot d \cdot {( {μ}_{0} \cdot \frac{N}{l} )}^{2} \cdot A \cdot {r}^{2}$$

where:
a is a unitless shape factor (determined experimentally)
σ is the electrical conductivity of the rotor material (S/m).
d is the thickness of the conductor

$$μ 0 = 4 π \times 1 {0}^{- 7} \frac{H}{m}$$

(permeability of free space).
N is the number of turns in the stator coil.
l is the length of the magnetic path (m).
A is the effective area of the rotor exposed to the magnetic field (m²).
r is the average radius of the rotor (m).

Consider an eddy current actuator with the following parameters:
a=10.1
Rotor material: Aluminum with electrical conductivity

$$σ = 3.5 \times 1 {0}^{7} \frac{s}{m} .$$

Thickness of conductor is 0.01 m.
Effective area A=0.004 m².
Average radius r=0.03 m.
Number of turns N=100.
Magnetic path length l=0.02 m.

$${k}^{′} = 10.1 \cdot 3.5 \times 1 {0}^{7} \cdot 0.01 \cdot {( 4 π \times {10}^{- 7} \cdot \frac{100}{0.02} )}^{2} \cdot 0.004 \cdot {0.03}^{2} \approx 5.0 \times 1 {0}^{- 4}$$

Substituting the expressions for k′ and into the torque equation:

$$T = 5. \cdot \times {10}^{- 4} \cdot {I}^{2} ⋅ ω$$

Case 1: Varying Current at Constant Angular Velocity, assume the rotor rotates at a constant angular velocity ω=300 rad/s.

The theoretical torque for different current values:
1. Current I=1 A

$$T = 5. \cdot \times {10}^{- 4} \cdot {( 1 )}^{2} \cdot 300 = 5. \cdot \times {10}^{- 4} \cdot 300 = 0.15 Nm$$

2. Current I=2 A

$$T = 5. \cdot \times {10}^{- 4} \cdot {( 2 )}^{2} \cdot 300 = 5. \cdot \times {10}^{- 4} \cdot 4 \cdot 300 = 0.6 Nm$$

3. Current I=4 A

$$T = 5. \cdot \times {10}^{- 4} \cdot {( 4 )}^{2} \cdot 300 = 5. \cdot \times {10}^{- 4} \cdot 16 \cdot 300 = 2.4 Nm$$

Observation: The torque increases quadratically with current, demonstrating significant torque output even with modest increases in current.

Case 2: Varying Angular Velocity at Constant Current, assume the stator current is held constant at I=2 A.

### Compute Torque for Different Angular Velocities:

1. Angular Velocity ω=100 rad/s

$$T = 5. \cdot \times {10}^{- 4} \cdot 4 \cdot 100 = 0.2 Nm$$

2. Angular Velocity ω=300 rad/s

$$T = 5. \cdot \times {10}^{- 4} \cdot 4 \cdot 300 = 0.6 Nm$$

3. Angular Velocity ω=500 rad/s

$$T = 5. \cdot \times {10}^{- 4} \cdot 4 \cdot 500 = 1. Nm$$

Observation: Torque increases linearly with angular velocity when current is held constant, indicating that higher rotor speeds result in greater torque output.

By varying both current and angular velocity, the torque output can be finely tuned to meet specific application needs.

For example, at I=3 A and ω=150 rad/s:

$$T = 5. \cdot \times {10}^{- 4} \cdot {( 3 )}^{2} \cdot 150 = 5. \cdot \times {10}^{- 4} \cdot 9 \cdot 150 = 0.6 \; 75 Nm$$

### Practical Implications:

Force Control: By adjusting the stator current, the system can rapidly change the torque output, allowing for precise force control.
Energy Efficiency: Operating at higher speeds with lower currents can achieve the same torque as higher currents at lower speeds, potentially improving energy efficiency.
Thermal Management: Lower currents reduce resistive heating in the stator coils, mitigating thermal issues and extending component lifespan.
Compliance Adjustment: The ability to vary torque output dynamically enables the actuator to adapt to external forces, enhancing safety and performance in collaborative environments.

### Design Considerations:

Material Selection: Choosing rotor materials with high electrical conductivity enhances torque output due to increased eddy current generation.
Cooling Requirements: Effective thermal management strategies, such as incorporating cooling fins or forced air cooling, are essential to dissipate heat generated by eddy currents.
Control Systems: Implementing advanced control algorithms allows for real-time adjustment of current and speed, optimizing performance based on operational demands.
   Integration into Control Methodologies

The quantitative relationships outlined above can be integrated into the control methodologies discussed in FIGS. 17 and 18. In an encoder-equipped system FIG. 17, the controller 900 can utilize real-time data on rotor speed (o) and adjust the stator current (I) to achieve the desired torque output (T). By referencing the torque equation, the controller can predict the necessary current adjustments to respond to changes in load or desired movement profiles.

In systems without direct position feedback FIG. 18, pre-calculated torque values corresponding to specific currents and rotor speeds can be stored in the controller's memory. The controller can adjust the current supplied to the stator based on the desired torque output, relying on the established relationship between current, speed, and torque.

Suppose the actuator is required to apply a torque of 0.5 Nm to perform a specific task. Using the torque equation:

$$T = 5. \cdot \times {10}^{- 4} \cdot {I}^{2} \cdot ω$$

Assuming the rotor speed is ω=300 rad/s, solve for the required current I:

$$0.5 = 5. \cdot \times {10}^{- 4} \cdot {I}^{2} \cdot 300$$

$${I}^{2} = \frac{0.05}{5. \cdot \times {10}^{- 4} \cdot 300} = \frac{0.5}{0.15} \approx 3 \text{.33}$$

$$I = \sqrt{3.33} \approx 1.82 A$$

The controller sets the stator current to approximately 1.82 A to achieve the desired torque at the given rotor speed. If the rotor speed changes, the controller recalculates the required current accordingly.

If the load on the prime mover increases enough it can cause a decrease in rotor speed due to increased torque demand, the controller detects the change via feedback mechanisms and adjusts the current to maintain the required torque output.

For instance, if rotor speed drops to 290 rad/s, the new current I′ needed is:

$$0.5 = 5.0 \times 1 {0}^{- 4} \cdot {I}^{′2} \cdot 90$$

$${I}^{′2} = \frac{0.5}{5.0 \times 1 {0}^{- 4} \cdot 290} = \frac{0.5}{0.145} \approx 3.45$$

$${I}^{′} = \sqrt{3.45} \approx 1.86 A$$

The controller increases the stator current to approximately 1.86 A to compensate for the reduced speed, maintaining consistent torque output.

### Generator-Based Actuator Embodiment

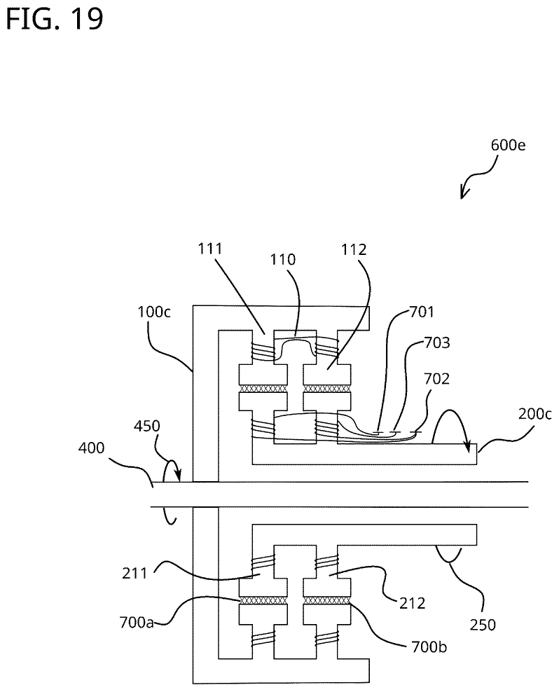

FIG. 19 illustrates an embodiment of the invention where a generator-based actuator 600c is employed. This is a theoretical embodiment that operates similarly to, and is a simplification of, a Brushless Excitation Synchronous Generator (BESG). However, unlike in BESGs, where the stator is fixed and thus does not require brushes, this embodiment incorporates brushes on the stator to enable its rotation. Missing from the drawing are the frame and mechanical outputs. This cross-sectional schematic shows a drive shaft 400 connected to the rotor 100c, which continues through the assembly to deliver motive power 450 to downstream actuators. The rotor 100c is equipped with two coils: a pickup coil 111 and a drive coil 112. These are paired with two coils on the stator 200c: the excitation coil 211 and the output coil 212. Together, these components form the generator circuit.

The generator circuit operates as follows:
A power/control signal 701 is delivered to the unit via slip rings or other suitable methods, creating a current between the power source and the ground connection 702.
This current energizes the excitation coil 211, generating a magnetic field 700a.
The magnetic field induces a current in the pickup coil 111 on the rotor 100c.
The induced current travels through a closed loop connecting the pickup coil 111 and the drive coil 112, generating its own magnetic field 700b.
This field induces a current in the output coil 212, generating usable power between the output connection 703 and the common ground.

This embodiment eliminates the need for permanent magnets, thereby avoiding challenges such as cogging and unwanted output torque when the device is unpowered. Additionally, this design captures a portion of the transferred energy as electrical output, reducing heat generation compared to other embodiments and improving efficiency. However, the increased complexity makes this embodiment more suitable for larger assemblies where the added benefits justify the more intricate construction.

The present invention offers several significant advantages, including precise control over torque output, reduced maintenance due to the non-contact transmission of torque, and a highly modular design that supports a wide array of configurations. The ability to integrate various cooling mechanisms and alternative electrical machines further enhances the system's versatility and performance. Whether applied in robotics, industrial automation, or prosthetics, this actuator system represents a substantial advancement in the field of electromechanical design.

1. An actuation system, comprising:
a drive shaft
a rotor connected to the drive shaft, the rotor in a constant state of rotation with the drive shaft during operation;
a stator configured to rotate, creating an inductive electromagnetic field coupling with the rotor, forming a rotor and stator pair; and
a frame within which the drive shaft, rotor and stator pair rotate;
wherein the stator rotates independently from the rotor and the frame, extracts torque from its interaction with the rotor via the created electromagnetic field and transmits the torque to a mechanical output between the stator and the frame, thereby expanding functionality of the actuator system.

2. The actuation system of claim 1, wherein external load forces acting on the stator which minimize axial or radial forces are converted to torque and transmitted to the mechanical output.

3. The actuation system of claim 2, wherein the drive shaft is driven by an external power source and the mechanical output is selected from a group consisting of cables, belts, and gears.

4. The actuation system of claim 1, further comprising a plurality of rotor and stator pairs arranged linearly along the drive shaft, wherein each one of the plurality of rotor and stator pairs is sized based on a required torque output.

5. The actuation system of claim 4, wherein each stator and rotor pair is independently controllable through dedicated electronic control units, each operable to individually adjust current and thus the torque output based on real-time load conditions.

6. The actuation system of claim 1, wherein the stator or frame comprises sensors for monitoring operational parameters, including but not limited to temperature, rotational speed, or position, allowing for real-time control and system diagnostics.

7. The actuation system of claim 1, wherein the stator and rotor pair are configured to function as an eddy current brake by inducing eddy currents that generate braking torque proportional to relative rotational speed and strength of the electromagnetic field.

8. The actuation system of claim 1, wherein the stator and rotor pair are configured to function as an electric generator by converting rotational mechanical energy into electrical energy through electromagnetic induction, thereby allowing for the recapture of energy during activation.

9. The actuation system of claim 7, wherein the stator and rotor are configured to collectively function as an electric motor by converting the electrical energy into rotational mechanical energy through electromagnetic induction.

10. The actuation system of claim 1, wherein the frame includes ventilation openings configured to allow air flow through the system, and the rotor comprises fins and cooling channels for convective cooling, thereby dissipating heat generated during operation, optimizing system performance, and preventing overheating.

11. The actuation system of claim 1, wherein the rotor and stator are configured for integration with advanced cooling systems, including liquid cooling or phase-change materials to further improve thermal management.

12. A method for operating an actuation system including a rotor, stator, drive shaft and frame, comprising the steps of:
(a) maintaining the rotor, stator and drive shaft within the frame;
(b) connecting the rotor to the drive shaft;
(c) maintaining the drive shaft and the rotor in constant rotation during operation of the actuator system;
(d) independently rotating the stator and coupling it to the rotor creating a first rotor and stator pair;
(e) extracting torque by the stator via an inducted electromagnetic field created by the couple with the rotor; and
(f) transmitting the torque to a mechanical output between the stator and the frame, thereby expanding functionality of the actuator system.

13. The method of claim 12, wherein the amount of torque is determined based on any one or more of, rotational velocity of the drive shaft and rotor as measured by one or more rotary encoders fixedly mounted to the rotor or drive shaft, the electrical current applied to each rotor stator pair, and displacement of a control mechanism connected to the stator as measured by rotary encoders fixed relative to the frame, thereby enabling adaptive control based on load conditions.

14. The method of claim 12, further comprising a step for providing a plurality of rotor and stator pairs arranged linearly along the drive shaft, wherein each one of the plurality of rotor and stator pairs are sized based on a required torque output.

15. The method of claim 14, wherein each stator and rotor pair is independently controllable through dedicated electronic control units, each operable to individually adjust current and thus the torque output based on real-time load conditions.

16. The method of claim 12, wherein the stator or frame comprises sensors for monitoring operational parameters, including but not limited to temperature, rotational speed, or position, allowing for real-time control and system diagnostics.

17. The method of claim 12, wherein the stator and rotor pair are configured to function as an eddy current brake by inducing eddy currents that generate braking torque proportional to relative rotational speed and strength of the electromagnetic field.

18. The method of claim 12, wherein the stator and rotor pair are configured to function as an electric generator by converting rotational mechanical energy into electrical energy through electromagnetic induction, thereby allowing for the recapture of energy during activation.

19. The method of claim 12, wherein the stator and rotor are configured to collectively function as an electric motor by converting electrical energy into rotational mechanical energy through electromagnetic induction.

20. The method of claim 12, wherein the frame includes ventilation openings configured to allow air flow through the system, and the rotor comprises fins and cooling channels for convective cooling, thereby dissipating heat generated during operation, optimizing system performance, and preventing overheating.
